(19) United States
(12) Patent Application Publication
(10) Pub. No.: US 2011/0214061 A1
(43) Pub. Date: Sep. 1, 2011

(54) User Interface for Managing Client Devices

(76) Inventors: Ashley Edwardo King, Tijeras, NM (US); Steve J. Shattil, Cheyenne, WY (US)

(21) Appl. No.: 13/036,778

(22) Filed: Feb. 28, 2011

Related U.S. Application Data
(60) Provisional application No. 61/308,997, filed on Mar. 1, 2010.

(51) Int. Cl. G06F 15/16; G06F 3/048

(52) U.S. Cl. 715/736

(57) ABSTRACT

In a content delivery network, a client-side graphical user interface displays a plurality of media widgets associated with a plurality of user-selectable media channels and a plurality of device widgets associated with a plurality of user-selectable client devices. A user control is configurable for interacting with the media widgets and the device widgets, and enables a user to move a presentation of a selected media channel from a first client device to at least a second client device. A media channel processor configures the selected media channel for presentation on the client devices.

### CROSS-REFERENCE TO RELATED APPLICATIONS

This application claims priority under 35 U.S.C. 119(e) to U.S. Provisional Application Ser. No. 61/308,997, filed Mar. 1, 2010.

### BACKGROUND OF THE INVENTION

I. Field of the Invention

The present invention relates to a system and a method for processing media resources for presentation on client devices, and in particular, to such a system and method for managing and routing selected media resources to selected client devices.

II. Description of the Related Art

Media files include video, music, text, software, project files, and digital datasets. Media resources, such as media files, content streams, related metadata, and other media services may be stored in a central location or distributed over a content delivery network (CDN). Users access the media resources by employing client devices that interface with a network on which the media is stored.

A user may employ multiple client devices for accessing media resources, and the user may employ these multiple devices at the same time. For example, a user may simultaneously operate a smart phone, a laptop computer, and a set-top box. However, each device manages its own network connection, and it formats and presents the received media independently of the other client devices. Furthermore, the devices may access media resources via different networks. The ability to share media between devices is cumbersome to the user, and the ability to create a unified media experience for the user is limited or non-existent.

There is a need to simultaneously access multiple media resources, but this need is not met by current state-of-the-art technologies. There is a need to facilitate access to media resources when multiple client devices are under a user's control. There is a need for a mechanism that allows a user to seamlessly operate multiple client devices. These and other needs are not currently met by the prior art.

### SUMMARY OF THE INVENTION

Although some aspects of the invention are described with respect to certain benefits and advantages that may be realized, such benefits and advantages are only exemplary and not intended to define or limit the scope of the claimed invention. Moreover, additional and/or alternative benefits and advantages may be realized without departing from the scope of the claimed invention.

Some aspects of the invention allow a user to simultaneously employ multiple devices to receive, control, and interact with a given media resource. Such aspects are both content- and device-agnostic, meaning that the client devices are configured to present media resources and transfer the presentation of media resources from one device to another in a manner that is seamless to the user. This provides the user with an integrated experience across disparate devices, even if the devices are served by different networks. A related aspect of the invention enables user-centric aggregation and delivery of media resources. For example, one aspect of the invention enables a user to select and combine media resources from different devices (and/or sources) and select which client device(s) to present the media. Another aspect of the invention allows real-time routing, control, and integration of media via multiple client devices. In yet another aspect of the invention, real-time routing, control, and integration of media resources may be provided by content providers.

Accordingly, one aspect of the present invention is directed to one or more computer-readable media having computer-executable instructions embodied thereon for performing a method for enabling a user to select and assign media channels for presentation on at least one of a plurality of client devices under the user's control. The method includes displaying the client devices and the media resources on a client-side graphical user interface (GUI). A user control is provided for associating at least one of the media resources with at least one of the client devices. In response to a user input, the method provides for device-specific configuring of at least one selected media channel for a selected client device.

In another aspect of the invention, a computer system resides on one or more client devices and is configurable for interacting with a plurality of client devices. The computer system comprises a media channel processor and a client-side graphical user interface (GUI). The media channel processor is responsive to user input for configuring selected media channels for presentation on at least one of a plurality of user-selectable client devices. The GUI comprises a canvas display of the plurality of user-selectable client devices and available media channels, and a user control for assigning the media channels to the devices.

### BRIEF DESCRIPTION OF THE DRAWINGS

The invention is illustrated in the figures of the accompanying drawings which are meant to be exemplary and not limiting, in which like references are intended to refer to like or corresponding parts, and wherein:

FIG. 1 is a block diagram of a client device configured in accordance with an aspect of the invention;

FIG. 2 is a block diagram depicting how a patchbay, which may comprise a combination of hardware and software, is configured for communicatively coupling multiple client devices together and coupling the client devices to media resources;

FIG. 3 depicts a canvas graphical user interface for allowing a user to view, control, and interact with client devices and media assets;

FIG. 4 depicts a canvas graphical user interface associated with a method implemented in accordance with one aspect of the invention;

FIG. 5 is a flow diagram depicting a method for processing user inputs and presenting a selected media resource on a selected client device according to an aspect of the present invention;

FIG. 6 is a flow diagram illustrating a method for formulating a request for media configured in accordance with one aspect of the invention;

FIG. 7 is a block diagram of a computer system configured according to an aspect of the invention;

FIG. 8 is a flow diagram illustrating a computer-implemented method for configuring media channels to be presented on at least one of a plurality of client devices; and

FIG. 9 depicts source-code segments of a computer program residing on one or more computer-readable media and configured to perform a method in accordance with an aspect of the invention;

### DETAILED DESCRIPTION

In the following description, reference is made to the accompanying drawings that form a part hereof, and in which is shown by way of illustration specific aspects in which the invention may be practiced. It is to be understood that other aspects and embodiments may be utilized, and structural changes may be made without departing from the scope of the present invention.

Some aspects of the invention are described as processes, which may be depicted as a flowchart, a flow diagram, a data flow diagram, a structure diagram, or a block diagram. Although a flowchart may show the operations as a sequential process, many of the operations can be performed in parallel or concurrently. In addition, the order of the operations may be re-arranged. A process is terminated when its operations are completed, but could have additional steps not included in the figures. A process may correspond to a method, a function, a procedure, a subroutine, a subprogram, etc. When a process corresponds to a function, its termination corresponds to a return of the function to the calling function or the main function.

Moreover, as disclosed herein, the term “storage medium” may represent one or more devices for storing data, including read only memory (ROM), random access memory (RAM), magnetic RAM, core memory, magnetic disk storage mediums, optical storage mediums, flash memory devices and/or other machine readable mediums for storing information. The term “computer-readable medium” includes, but is not limited to portable or fixed storage devices, optical storage devices, wireless channels and various other mediums capable of storing, containing or carrying instruction(s) and/or data.

Furthermore, embodiments of the invention may be implemented by hardware, software, firmware, middleware, microcode, hardware description languages, or any combination thereof. When implemented in software, firmware, middleware or microcode, the program code or code segments to perform the necessary tasks may be stored in a machine-readable medium, such as a storage medium. One or more processors may perform the necessary tasks. A code segment may represent a procedure, a function, a subprogram, a program, a routine, a subroutine, a module, a software package, a class, or any combination of instructions, data structures, or program statements. A code segment may be coupled to another code segment or a hardware circuit by passing and/or receiving information, data, arguments, parameters, or memory contents. Information, arguments, parameters, data, etc. may be passed, forwarded, or transmitted via any suitable means including memory sharing, message passing, token passing, network transmission, etc.

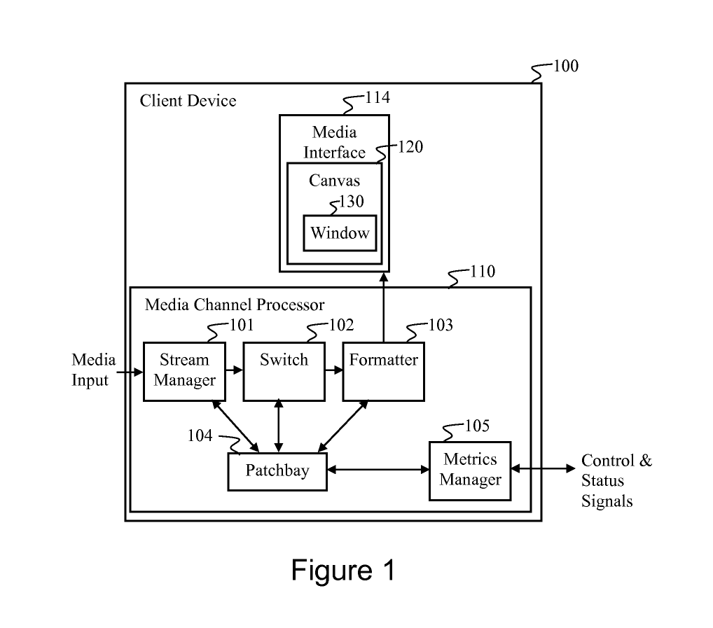

FIG. 1 is a block diagram of a client device 100 configured in accordance with an aspect of the invention. A media channel processor 110 configures a media input for display on the client device 100. The media channel processor 110 may comprise a plurality of functional blocks, including a stream manager 101, a switch 102, and a formatter 103, for processing media signals received by the device 100. The media input may be processed based on a combination of criteria, including the device's 100 display capabilities, user input, network performance, stream bandwidths that are available at the client, and device-control directives originating from the network. Other criteria may be employed by the media channel processor 110 for selecting, formatting, or otherwise adapting the media input.

The stream manager 101 receives media input and meta-data about each available stream matching a predetermined criterion. For example, the stream manager 101 may be responsive to a user input in which the user selects a particular media channel. The selected media channel may be available in a plurality of different media streams, each stream having a different bandwidth. The stream manager 101 typically receives meta-data about which stream bandwidths are available.

The switch 102 compares the available stream bandwidths to the quality of service that the client's communication link can support. The switch 102 may consider other criteria as well, such as limitations of what the client device can display, how many media channels are being displayed, network bandwidth used by other client applications, and any limitations imposed by how the media channel is being displayed. For example, when a user reduces the size of a window used to display a media channel, the switch 102 may select a stream with a lower bandwidth. The switch 102 may calculate the link's bandwidth. For example, an average link bandwidth over a predetermined time interval may be calculated, and the switch 102 may select one of the stream bandwidths below the average link bandwidth.

In one aspect of the invention, the client device comprises a mobile terminal communicatively coupled to a mobile wireless network. The performance of the end-to-end communication link from the content provider network (e.g., an edge node) to the client device typically depends highly on the performance of the mobile wireless network. The quality of wireless link can fluctuate greatly due to many factors, including fading, shadowing, network loading, interference, and service interruptions while transferring to adjacent sectors and cells. In this case, the switch 102 performs a performance analysis step (which may comprise calculating data throughput) and media resource selection step.

The performance analysis step may comprise collecting network performance data directly from the network. Network performance data may comprise network loads, average bit error rate, power levels, coverage area, quality of service, and link budgets for the mobile wireless network in the vicinity of the client device. Network performance data may include many different types of calculations and measurements pertaining to how well the mobile wireless network is able to serve the client device. For example, network performance data may comprise measurements and/or calculations of link reliability, average link throughput, peak link throughput, and/or latency.

Performance analysis may comprise collecting network performance data that is specific to the mobile client device. Such data may be collected from the client device and/or the mobile wireless network. For example, network performance data may include the client's assigned transmit power level, measured bit error rate, channel estimates of the wireless link connecting the client to the network, average data rate, latency, and/or the coding rate of any channel coding or error correction coding employed. Other network performance data may be obtained from measurements produced by the client and/or the network.

In another aspect of the invention, the performance analysis step comprises indirectly analyzing the performance of the mobile wireless network. For example, since the wireless link is typically the bottleneck of a data network, aspects of the invention may provide for measuring the overall performance of a heterogeneous network (i.e., a network comprising wireless and wired network portions).

The step of selecting which media resources to make available to the client device comprises selecting media resources having bandwidths that are appropriate for the communication link serving the client device. For example, screen size in pixels and the number of frames per second of a video transmission may be selected not to exceed a predetermined threshold calculated from the client's measured or estimated communication link bandwidth. Specifically, the bandwidth of the media resource should not exceed the average bandwidth of the link unless some degree of latency is tolerable. Thus, various considerations in addition to the wireless link performance may be employed as part of the step of selecting the media resources.

The formatter 103 is coupled to a media interface 114 on the client device 100. However, other aspects of the invention provide for the formatter 103 being coupled to more than one client device. Specifically, the formatter 103 may be coupled to a plurality of media interfaces, wherein each media interface resides on a different client device. For example, a user may wish to display media on multiple client devices, such as a cellular phone, a laptop computer, and a home-entertainment system. In such aspects, components of the media channel processor 110 may reside on more than one client device.

The media interface 114 is a graphical user interface comprising a canvas display 120 in which one or more windows, such as window 130, are employed for displaying the media. The formatter 103 formats the stream for the client device 100 on which the media stream is presented. For example, the formatter 103 may adapt the video portion of a media stream to the size of the window 130 in which the stream is displayed.

In one aspect of the invention, the media channel processor 110 further comprises a metrics manager 105 communicatively coupled to the stream manager 101, the switch 102, and the formatter 103 by a patchbay 104. Other functional blocks (not shown) may also be included. It will be appreciated that the stream manager 101, the switch 102, the formatter 103, the metrics manager 105, and the patchbay 104 may comprise any combination of hardware and software.

The patchbay 104 is a connection mechanism that enables a communication link between functional modules shown in FIG. 1. For example, the patchbay 104 enables status messages from the stream manager 101, the switch 102, and the formatter 103 to be transmitted to the metrics manager 105. Furthermore, the patchbay 104 may provide other communication links between functional modules.

In one aspect of the invention, the patchbay 104 provides a link between the window 130 and the metrics manager 105. For example, the window 130 may send a message to the metrics manager 105 when network-link degradation causes the window's 130 buffer to empty, interruption in the video occurs, or some other quality reduction in the video occurs. The metrics manager 105 sends a message to the switch 102 via the patchbay 104 to instruct the switch 102 to re-calculate the average bandwidth of the link. The switch 102 calculates the average bandwidth over a new time interval and compares the updated bandwidth value to the bandwidth of the available streams indicated by the stream manager 101. The switch 102 selects a new stream having a bandwidth that more closely matches the updated average bandwidth.

In another aspect of the invention, the metrics manager 105 is responsive to channel performance information received from the network and/or the client device 100. The received information may comprise channel coding and/or error correction coding of network signals received and/or transmitted by the client device 100, power control instructions from the network to the client device 100, received signal strength, channel access instructions from the network to the client device 100, handover instructions from the network to the client device 100, requests for retransmission by the client device 100 to the network, channel estimates for a wireless network serving the client device 100, bit error rate of data received by the client device 100, etc. Other link information may also be received by the metrics manager 105. The channel performance information may comprise network performance information received from the network, such as network loads, channel bandwidth, quality of service metrics, coverage area, and the like. The channel performance information may comprise an indication that the client device 100 has migrated from one network to another, or is capable of being served by multiple networks simultaneously. Depending on the received information, the metrics manager 105 may respond by sending a message to the switch 102 via the patchbay 104 to instruct the switch 102 to take a predetermined action, such as performing a link bandwidth calculation and/or selecting a new stream.

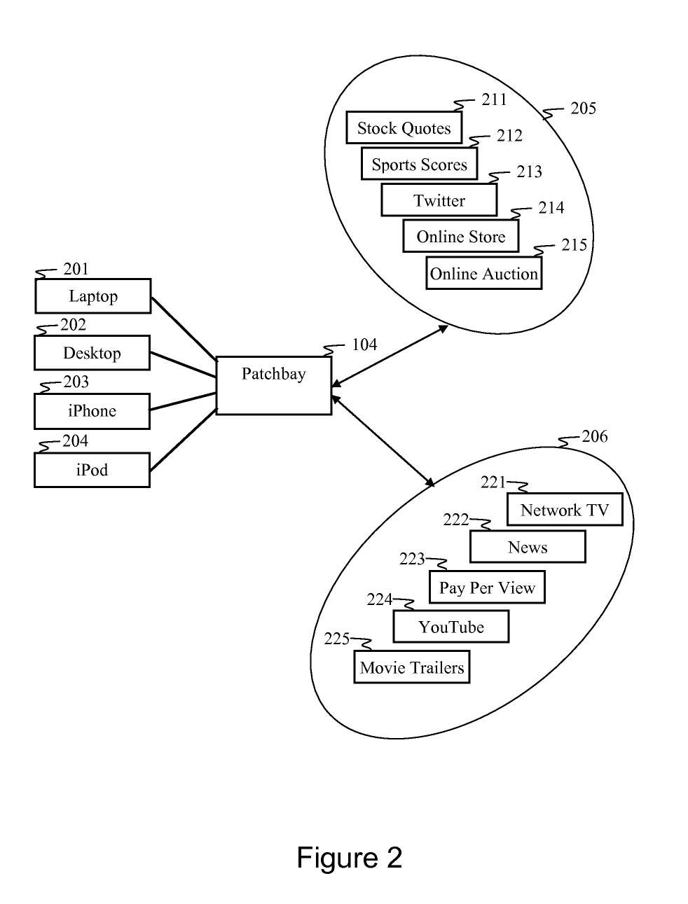

In another aspect of the invention, the patchbay 104 comprises a means for connecting one or more client devices and/or software applications to one or more media resources. As shown in FIG. 2, a user may employ a plurality of client devices, such as a laptop computer 201, a desktop computer 202, a smart phone 203, and auxiliary multimedia devices, such as an iPod 1204 manufactured by Apple Computer Company. The patchbay 104 communicatively couples the client devices 201-204 together. The patchbay 104 is also communicatively coupled to a data cloud 205 and a video cloud 206.

The data cloud 205 comprises a plurality of data sources 211-215, which may be presented by specific data services. For example, the data sources may include a stock quote server 211, a sports news server 212, a social networking application (such as Twitter) 213, an online store 214, and an online auction 215. Since the data sources 211-215 may be interactive, the patchbay 104 provides for bi-directional data communications between the client devices 201-204 and the data cloud 205.

The video cloud 206 comprises a plurality of streaming video applications and/or services, such as a network television server 221, a news server 222, a subscription movie and sports server (such as Pay Per View) 223, a video-sharing server (such as YouTube) 224, and a movie preview server 225. The video resources may be interactive. For example, the news server 222 and the video-sharing server 224 may permit the user to upload videos. Thus, the patchbay 104 may provide for bi-directional video communications between one or more of the client devices 201-204 and the video cloud 206.

In one aspect of the invention, the patchbay 104 enables media sharing between the devices 201-204. For example, the patchbay 104 may allow a user to view a video stream on a first client device, such as the laptop 201, while listening to the audio content of the video on a second client device, such as the iPod 204. Furthermore, the patchbay 104 may combine a plurality of media channels for presentation on a single device 201-204. The patchbay 104 may comprise software with a graphical user interface for enabling the user to select and control media streams presented on each of the client devices 201-204.

According to one aspect of the invention, the patchbay 104 is responsive to user input for directing media to one or more of the devices 201-204, and the patchbay 104 comprises software for selecting media, managing media-stream bandwidth, and formatting the media streams for each of the client devices 201-204. For example, the patchbay 104 may be a component of a media channel processor comprising a stream manager, a switch, and a formatter. Thus, the patchbay 104 can enable a user to seamlessly present the media on different client devices 201-204, and seamlessly transfer media from one client device to another.

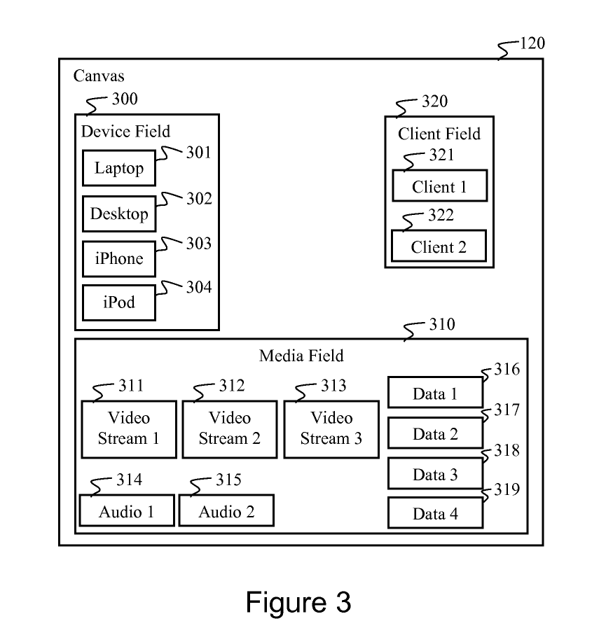

FIG. 3 depicts a graphical user interface, such as canvas interface 120, for allowing a user to view, control, and interact with client devices and media assets. A device field 300 comprises device widgets 301-304 indicating which client devices are available to the user. For example, client widgets 301-304 may indicate a laptop computer 301, a desktop computer 302, a smart phone (such as an iPhone) 303, and any auxiliary media devices (such as an iPod) 304. Other client devices may be included, such as set-top boxes, televisions, and stereos (not shown).

The canvas interface 120 also depicts a media field 310, which comprises a graphical display of media assets that are available to the user. Media assets are depicted by media widgets 311-319, such as media widgets for indicating video files or streaming video links 311, 312, 313, media widgets indicating audio files or streaming audio links 314 and 315, and/or media widgets indicating data files or data links 316, 317, 318, and 319.

Video files employed by aspects of the invention may include, by way of example, but without limitation, 3GPP multimedia files, Advanced Systems Format files, Audio Video Interleave files, Flash Video files, Flash Movie files, iTunes Video files, Matroska Video files, Apple QuickTime Movie files, MPEG Video files, MPEG-4 Video files, Real Media files, HD Video Transport Streams, DVD Video Object files, Windows Media Video files, or other video file formats.

Audio files or audio links 314 and 315 may include the audio portion of any video file or video stream 311, 312, and 313. Audio files that may be employed by aspects of the invention include, by way of example, but without limitation, Advanced Audio Coding files, Audio Interchange files, Interchange File Format, Media Playlist files, MIDI files, MP3 Audio files, MPEG-2 Audio files, Real Audio files, WAVE Audio files, and Windows Media Audio files.

Data files or data links 316, 317, 318, and 319 may include any of various types of text files, data files, image files, web files, and game files. Data files or data links 316, 317, 318, and 319 may also include client-side applications, such as a Twitter client.

Widgets, as defined herein, are typically focused applications displayed on a relatively small portion of a canvas display and are configured to perform a variety of pre-programmed functions. However, widgets may be configurable for being resized by the user. For example, a media widget pointing to a video channel may be expanded so the video fills the entire canvas display. Media widgets are configured for providing video, audio, and/or text content. Media widgets may be configured to present their content on the canvas. For example, a media widget may include any media, such as a text element, a graphics element, a multimedia element, an audio element, or any other audio, graphical and/or display element. Similarly, a media widget may be a pointer to content. Thus, media widgets may include links, pointers, files, instructions, and any user controls or other mechanisms for accessing media content. Such media widgets may include (among other things) primary content, secondary content, and/or sponsored content. For example, a weather widget may display the current weather for the user's location. A stock-ticker widget may display prices for pre-selected stocks in real time. An Internet widget may display an Internet Browser window. A game widget may allow the user to play a game within the widget. A sports widget may allow the user to watch highlights from sporting events. A television widget may allow the user to view a current or previously televised show. A social networking widget may allow the user to interact with other users via social, business, or other networking applications, such as Twitter, Facebook, and Linked In.

Media widgets may provide access to software applications. For example, a spread-sheet widget may allow a user to employ a smart phone for interacting with a spread-sheet program running on the user's desktop computer. A media channel or file type for a corresponding media widget may be associated with at least one software application residing on at least one client device. For example, a media player selectable by the user and/or the content provider may be launched automatically in response to a user selection of the media widget. In one aspect of the invention, selecting a software media widget and associating it with a device causes the associated client device to activate a specific client application. In other aspects, the software media widget is configured to activate a process that causes the client device to download the appropriate client application. In another aspect of the invention, the software media widget opens a software-as-a-service session for the selected device.

In some aspects of the invention, media widgets can be moved to device widgets. For example, a user may click and drag a media widget to a device widget. The media widget may be viewable on the canvas and/or within an application window inside a device widget. Each of the client devices may comprise a canvas, and media widgets may be displayed in the canvas display of one or more of the client devices. According to one aspect of the invention, a device widget may display the client device's canvas and any media widgets on that canvas.

Other types of widgets may be displayed on the canvas 120. For example, client widgets 321 and 322 in the client field 320 represent other users. A user may share media streams and/or applications with other users by associating the corresponding media widget(s) with any of the client widgets 321 and 322. Similarly, media offered by other users may appear as media widgets (not shown) associated with their respective client widgets 321 and 322.

Aspects of the invention may provide for various user controls for displaying widgets on a canvas and/or within other widgets. For example, widgets may be sized and/or positioned within the canvas by the user. Video-display controls may include controls for color, hue, resolution, mode, as well as other picture-display selections. Other presentation aspects of the widgets may be user-controllable as well. For example, audio controls may include volume, equalization, balance, and channel selection. Software widgets may comprise user-selectable controls for managing associated software applications. For example, version control and write protection features may be selectable. Controls for accessing and/or filtering media streams may be user-selectable as well. For example, media widgets may include user-selectable parental controls, virus protection, anti-phishing, spam filtering, ad blocking, etc.

In accordance with some aspects of the invention, certain limitations may be imposed on how widgets are presented. A content provider or network operator may restrict how a user can display a particular media widget, what client devices can display the media widget or media resource, and how many of a user's client devices may present the associated media at one time. For example, a stock ticker widget may only be displayed at the bottom of an application window, a banner advertisement may not be closed or minimized by the user, and certain video media widgets may appear only as icons and full-screen (e.g., full-canvas) displays.

In addition to displaying widgets directly on the canvas or within device widgets, media widgets can be displayed within other media widgets. For example, a multimedia widget may include an audio sub-channel widget corresponding to an audio sub-channel. When the audio sub-channel widget is displayed inside the multimedia widget, audio and video are presented together. However, the multimedia widget may allow the user to decouple the audio sub-channel from its associated video sub-channel such that the audio portion can be presented on a different device from that which the video portion is presented on. According to other aspects of the invention, media widgets may be embedded in web pages and/or in browser windows, over-laid on video widgets, and/or integrated into the workspace of a software application.

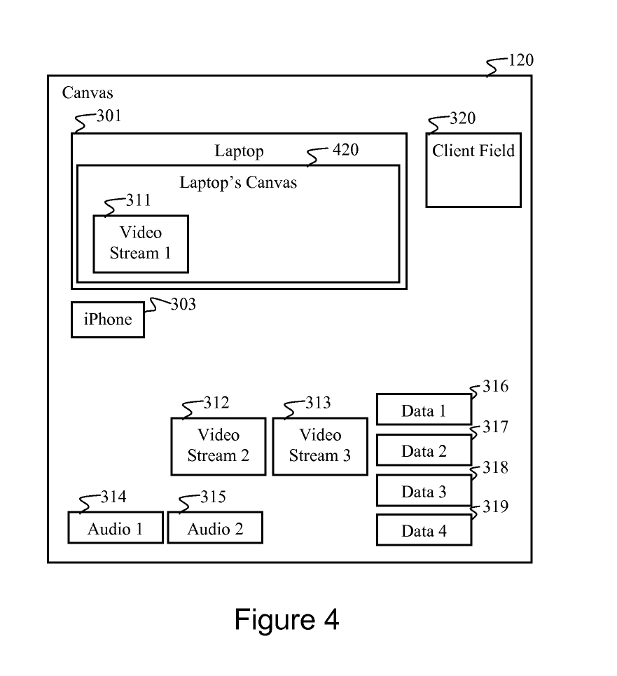

FIG. 4 depicts a graphical user interface display associated with a method implemented in accordance with one aspect of the invention. A user begins viewing a sporting event on a laptop computer, represented by the laptop widget 301 on the canvas display 120 of another client device (not shown). The sporting event may be delivered as high-definition video from a cable television modem in the user's home. The user may transfer the streaming video from the laptop to the iPhone by selecting the corresponding media widget (such as video media widget 311) in a canvas display (such as canvas display 420) in the laptop widget 301 and moving it to the iPhone widget 303. Once the media widget 311 is associated with the iPhone widget 303, it may be displayed in an iPhone canvas display (not shown) inside the iPhone widget 303.

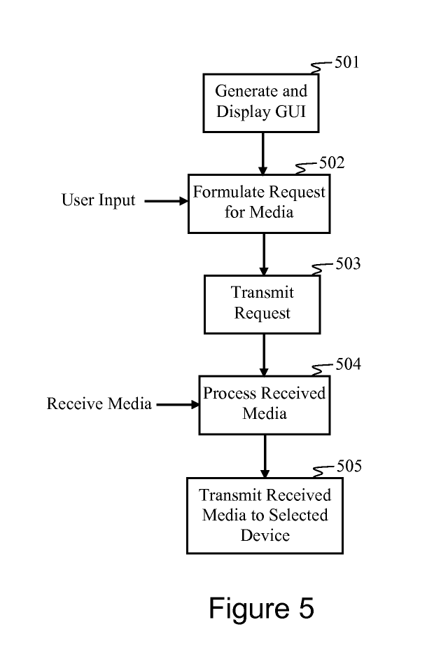

FIG. 5 is a flowchart depicting an example technique for processing user inputs and presenting a selected media resource on a selected client device. In one aspect of operation, a graphical user interface (GUI) is generated and displayed 501 on the media interface 114 (e.g., a view screen) of a client device for presentation to a viewer (i.e., a user). For example, software for producing the GUI may generate a canvas for displaying media widgets (such as media widgets 311-319) and device widgets (such as device widgets 301-304).

The step of generating the GUI 501 may comprise a plurality of steps, which are not shown in the figures. For example, the GUI software may be configured for first determining which media resources are available and which client devices are present. Then, the GUI software generates the media widgets (such as media widgets 311-319) for the media field 310 and the device widgets (such as device widgets 301-304) for the device field 300. The media interface 114 is configured for providing user-interaction capability for allowing the user to select client devices and media resources and then associate the selected media resources with the selected client devices. Then, in response to input through the GUI, the software can identify the media resources and devices selected by the user.

The user may select at least one of the media resources and at least one of the client devices. The user makes the selection based, at least in part, on the media widgets and the device widgets displayed on the canvas. Selecting the media resource may be performed when the user employs a mouse or touch screen to click on one of the media widgets. Selection further comprises associating the selected media resource with a selected client device. For example, the user interface may be configured to allow the user to move the selected media widget to a selected device widget.

In one aspect of the invention, the media interface 114 may be responsive to a user's selection of a media resource for determining which of the available client devices are configurable for presenting the selected media resource. This determination may be performed by the media interface 114 or the media channel processor 110. If necessary, GUI software residing on the media interface 114 updates the canvas display to indicate which client devices are selectable. For example, the GUI software may grey-out or remove one or more of the device widgets.

In another aspect of the invention, the media interface 114 may be responsive to a user's selection of a client device for determining which of the media resources are configurable for presenting on the selected device. This determination may be performed by the media interface 114 or the media channel processor 110. If necessary, the GUI software residing on the media interface 114 is instructed to update the canvas display to indicate which media resources are selectable. For example, the GUI software may grey-out or remove one or more of the media widgets.

Responsive to the user's input, the media interface 114 sends a message to the media channel processor 110, which formulates a request 502 and transmits the request 503 for the selected media resource to a content provider. A content provider comprises any entity that employs, operates, owns, or controls an electronic device (e.g., computing device) that transmits, processes, or stores media content for distributed service.

The media channel processor 110 typically formulates the request relative to the presentation capabilities of the selected device and the link bandwidth between the content provider and the client. In the case where the client device is served by a wireless network, such as a cellular network, the media channel processor 110 may formulate its request relative to the bandwidth of the wireless link, as the wireless link is typically the bottleneck (i.e., limiting factor) for the bandwidth of the total end-to-end link from the content provider (e.g., the edge node) to the client. The performance (e.g., bandwidth) of the wireless link may be obtained directly from performance measurements of the wireless network, or indirectly from measuring data throughput (and/or other performance metrics) of the total end-to-end link.

The media channel processor 110 may further adapt the request relative to the user's input. For example, the user may indicate a window size or quality of service for a selected video resource that affects which media stream bandwidth is selected by the media channel processor 110. The request may include an indication of the client's logical location; a request for an ftp, streaming, or other protocol session; an indication of the desired format; and an indication of the desired bandwidth. If a subscription for the requested media content is required, the media channel processor 110 may include subscription information in the request, such as information stored in a cookie at the client, log-in information, or the user's payment information.

Upon receiving the requested media, the media channel processor 110 processes the media 504 for the selected device and transmits the formatted media 505 to the selected device's media interface (not shown). Processing the received media 504 may comprise authenticating the input, decompressing the input, converting the input to a different format, identifying missing data, performing error correction, or otherwise processing the input. Furthermore, the media channel processor 110 may transmit the received media to media interface 114. For example, the video content of a media resource may be viewed in the selected media widget after it is placed inside the selected device widget.

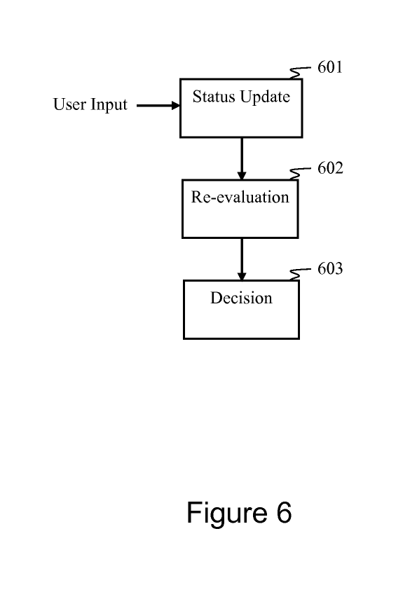

FIG. 6 is a flow diagram illustrating a method for formulating a request for media configured in accordance with one aspect of the invention. In a status-update step 601, software residing on the media interface 114 is responsive to user input and sends a message to the metrics manager 105 indicating a selection of a media resource for a particular client device. For example, a user input may be generated when the user expands a video display window on the client device. In a re-evaluation step 602, the metrics manager 105 is responsive to the status update 601 and instructs the switch 102 to re-evaluate the average bandwidth of the link and compare it to the bandwidth required for the new video window. The switch 102 selects the smaller of the two bandwidth values and compares it to the bandwidth of the available streams indicated by the stream manager 101. In a decision step 603, the switch 102 selects a new stream having a bandwidth that more closely matches the average bandwidth of the link.

In another aspect of the invention, the status-update step 601 is responsive to changes in a wireless link serving the client device. The metrics manager 105 receives a message from software residing on the client device (and/or the wireless network) indicating a change in the wireless link. In the re-evaluation step 602, the metrics manager 105 instructs the switch 102 to re-evaluate the average bandwidth of the wireless link. This may be done directly by measuring performance of the wireless link, or indirectly by measuring performance of a longer segment of the end-to-end link that includes the wireless link. In the decision step 603, the switch 102 determines if a new stream bandwidth should be selected, and, if necessary, selects a new stream.

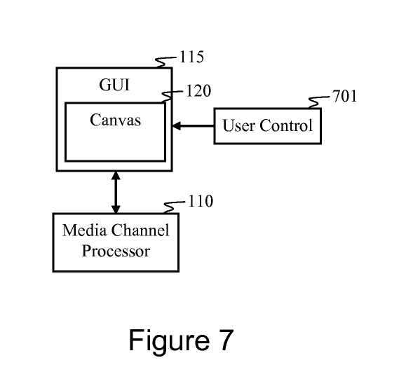

While generally described with respect to methods and software, some or all of the techniques and aspects of the invention may be embodied in respective systems or other devices. FIG. 7 is a block diagram of a computer system configured according to an aspect of the invention. The computer system may comprise a plurality of client devices, or the computer system may reside on a single client device, yet be configurable for interacting with a plurality of client-side devices.

The computer system comprises a media channel processor 110 coupled to a client-side graphical user interface (i.e., GUI 115). A user control 701 is communicatively coupled to the GUI 115 such that the GUI and the media channel processor 110 are responsive to user input. The GUI 115 may be displayed on the media interface 114 of one or more client devices. The GUI 115 may comprise a canvas display 120 for displaying device widgets (not shown) and media widgets (not shown).

The user control 701 may comprise a plurality of user-selectable buttons or a menu of user-selectable options that may be activated using a computer cursor, by touch screen activation, voice recognition activation, or by any other state-of-the-art activation. In one aspect of the invention, the device widgets indicate user-selectable client devices and the media widgets indicate available media resources, and the user control 701 responds when the user clicks or drags the widgets. The user control 701 conveys user inputs to the media channel processor 110, which selects and formats user-selected media resources for presentation on at least one of a plurality of the user-selectable client devices. In accordance with one aspect of the invention, the video portion of a multimedia stream may be displayed on the canvas 120.

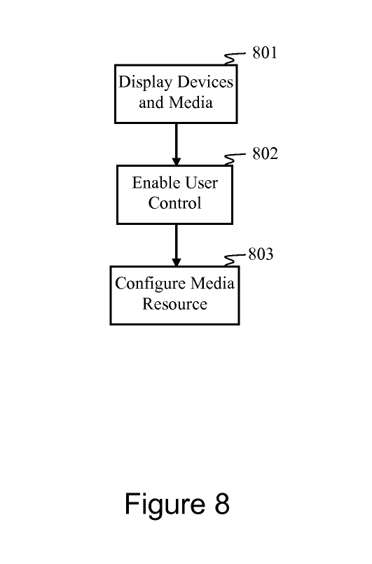

In some aspects of the invention, one or more computer-readable media have computer-executable instructions embodied thereon that, when executed, perform the method shown in the flow diagram of FIG. 8. A computer-implemented method for configuring media channels to be presented on at least one of a plurality of client devices comprises displaying the devices and the media resources 801 on a client-side GUI; enabling a user control 802 for associating at least one of the media channels with at least one of the client devices; and, responsive to a user input, configuring at least one selected media resource for at least one selected client device 803. In the case where a wireless link serves the client device, configuring at least one selected media resource 803 may comprise configuring the selected media resource with respect to performance of the wireless link.

As used herein, the term “associate” (as in associating at least one of the media channels with at least one of the client devices) means to combine, join together, connect or bring into relation. Associating a media channel with a client device may include switching the presentation of the media channel from one device to another.

As used herein, the term configure (as in configuring a media channel) means to adapt the media stream for presentation by the client device. This typically includes formatting the media stream relative to specific format requirements of the device's hardware and/or software. Formatting may include trans-coding. For video, configuring may include adapting the aspect ratio, frame rate, and/or picture resolution of the media stream. Configuring may further comprise selecting a media stream's bandwidth relative to constraints of either or both the device and the bandwidth of the network communication link with the device. A media channel may comprise multiple sub-channels. Configuring may include selecting one or more soundtracks from a video stream. In this case, the video portion of a video media stream is a media sub-channel, and each soundtrack is a media sub-channel. Other media sub-channels may be selected, including, by way of example, but without limitation, sub-titles, scrolling text, pop-up windows, child windows, and menus.

According to one aspect of the invention, the step of displaying media resources 801 further comprises generating at least one window display for displaying media content received by at least one of the devices. The step of enabling the user control 802 may further enable a user to redirect the media content to at least one of the devices. In one aspect, displaying media resources 801 may comprise displaying a user interface on a plurality of client devices. In another aspect, enabling the user control 802 may provide for a user control on at least one of the client devices for controlling media resources used by another one of the devices.

In yet another aspect of the invention, the step of enabling the user control 802 further comprises enabling a channel partitioning user control for partitioning a media channel into a plurality of media subchannels and enabling responsiveness to user input for distributing at least one subchannel to at least one of the devices. In this case, the step of configuring at least one selected media resource for at least one selected client device 803 may further comprise adapting the media resource relative to performance limitations of a wireless link serving the client device. For example, the wireless link may be a portion of the end-to-end link from a content provider (e.g., an edge node) to the client device. According to some aspects of the invention, the wireless link may comprise a wireless client sub-network linking multiple client devices together, in which case, the configuring step 803 obtains client sub-network performance information and may employ this performance information for adapting the media resource if necessary, including one or more of the media subchannels.

Aspects of the invention have been described with respect to widgets, which comprise both GUI elements and user-control elements. In certain aspects, each widget may comprise data formatted, stored, and/or otherwise defined as at least one of various data structures. A widget may further comprise at least one software application configured for displaying the widget, enabling user interaction with the widget, and being responsive to user input for processing media resources and/or controlling one or more of the client devices. Each widget may comprise one table or file or a plurality of tables or files stored on one computer or across a plurality of computers in any appropriate format.

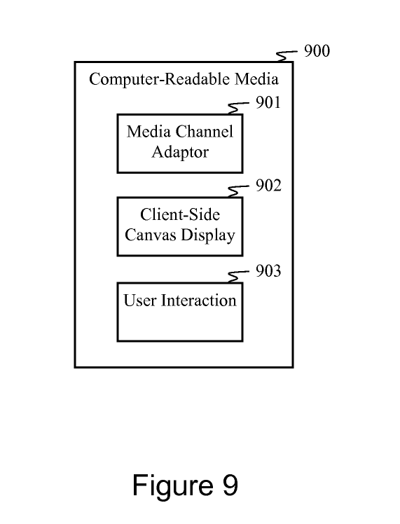

In accordance with one aspect of the invention, a computer program shown in FIG. 9 may reside on one or more computer-readable media 900 and be configurable for interacting with a plurality of client-side devices. The computer program comprises a media channel adaptor source-code segment 901, a client-side graphical canvas display source-code segment 902, and a user interaction source-code segment 903.

The media channel adaptor source-code segment 901 is responsive to user input for configuring selected media channels for presentation on at least one of a plurality of user-selectable client devices. The client-side graphical canvas display source-code segment 902 displays the client devices and available media resources. The user interaction source-code segment 903 enables a user to interact with the canvas display to select media resources and devices and assign selected media resources for presentation by selected devices.

As used herein, to assign (such as in assigning selected media resources for presentation by selected devices) means to give, allocate, designate, reserve, or set aside the selected media resources for the selected device(s). Furthermore, to assign includes transferring the selected media resources from one device to another.

1. A graphical user interface, comprising:
a media field comprising a plurality of media widgets associated with a plurality of user-selectable media channels;
a device field comprising a plurality of device widgets associated with a plurality of user-selectable client devices; and
a user control configurable for interacting with the plurality of media widgets and the plurality of device widgets, and responsive to a user input for moving a presentation of at least one selected media channel from at least a first user-selectable client device to at least a second user-selectable client device.

2. The graphical user interface recited in claim 1, further comprising a media channel processor responsive to user input and network performance for configuring a media channel for presentation on at least one of the plurality of user-selectable client devices.

3. The graphical user interface recited in claim 2, wherein the media channel processor comprises at least one of a stream manager, a switch, a formatter, and a metrics manager.

4. The graphical user interface recited in claim 2, wherein the media channel processor comprises a plurality of components residing on a plurality of client devices.

5. The graphical user interface recited in claim 1, wherein at least one of the device widgets comprises a canvas display for displaying a corresponding client device's graphical user interface.

6. The graphical user interface recited in claim 1, wherein at least one of the plurality of media widgets is configured to provide access to a software application.

7. The graphical user interface recited in claim 1, wherein display of at least one of the media field and the device field is controllable by a content provider.

8. The graphical user interface recited in claim 1, wherein the media field comprises at least one media widget associated with a media channel provided by another user.

9. The graphical user interface recited in claim 1, wherein the device field displays client devices belonging to a plurality of users, and the user control is configured for routing a media channel from a first client device of a first user to a second client device of a second user.

10. A computer system configurable for interacting with a plurality of client-side devices, comprising:
a media channel processor responsive to user input for configuring selected media channels for presentation on at least one of a plurality of user-selectable client devices; and
a client-side graphical user interface, comprising
a canvas display for depicting the plurality of user-selectable client devices and a plurality of media channels; and
a user control configurable for moving a presentation of a selected media channel from a first user-selectable client device to at least a second user-selectable client device.

11. The computer system recited in claim 10, wherein the media channel processor is responsive to performance of a wireless network serving at least one of the plurality of user-selectable client-side devices for configuring the selected media channels.

12. The computer system recited in claim 10, wherein the canvas display is configured for displaying the selected media channel.

13. The computer system recited in claim 10, wherein the canvas display is configured to display at least one additional canvas display employed by at least one of the first user-selectable client device and the second user-selectable client device.

14. The computer system recited in claim 10, wherein the media channel processor comprises at least one of a stream manager, a switch, a formatter, and a metrics manager.

15. The computer system recited in claim 10, wherein the user control is configured to provide access to a software application.

16. The computer system recited in claim 10, wherein the canvas display is controllable by a content provider.

17. The computer system recited in claim 10, wherein the user control is configured for routing a media channel received by the first user-selectable client device to the second user-selectable client device.

18. The computer system recited in claim 10, wherein the plurality of user-selectable client devices belongs to a plurality of users.

19. A computer-implemented method for configuring media channels to be presented on at least one of a plurality of client devices, comprising:
displaying the plurality of client devices and the media channels on a client-side graphical user interface;
enabling a user control for associating at least one of the media channels with at least one of the client devices; and
responsive to a user input, configuring at least one selected media channel for presentation on a selected client device.

20. The method recited in claim 19, wherein configuring is responsive to performance of a network serving at least one of the client devices.

21. The method recited in claim 19, wherein configuring comprises selecting the at least one selected media channel, managing media-stream bandwidth, and formatting media streams for at least one of the plurality of client devices.

22. The method recited in claim 19, wherein displaying further comprises displaying the at least one selected media channel.

23. The method recited in claim 19, wherein displaying comprises displaying at least one canvas display employed by at least one of the plurality of client devices.

24. The method recited in claim 19, wherein enabling the user control provides access to a software application.

25. The method recited in claim 19, wherein displaying is controllable by a content provider.

26. The method recited in claim 19, wherein enabling the user control provides for routing a media channel received by a first client device to a client device.

27. The method recited in claim 19, wherein the plurality of client devices belongs to a plurality of users.

28. A computer program residing on one or more computer-readable media configurable for interacting with a plurality of client-side devices, comprising:
a media channel adaptor source-code segment responsive to user input for configuring selected media for presentation on at least one of the plurality of client devices;
a client-side graphical canvas display source-code segment for displaying the plurality of client devices and a plurality of available media channels; and
a user control source-code segment responsive to user input for moving a presentation of a selected media channel from at least a first client device to at least a second client device.
